(19) United States
(12) Patent Application Publication
(10) Pub. No.: US 2018/0268581 A1
(43) Pub. Date: Sep. 20, 2018

(54) METHOD FOR GRAPHICALLY PRESENTING SENSOR DATA OF MULTIPLE WIND TURBINES, DEVICE FOR THIS PURPOSE, AND SYSTEM COMPRISING SAID DEVICE

(71) Applicant: Wobben Properties GmbH, Aurich (DE)

(72) Inventor: Simon DEMUTH, Hage (DE)

(21) Appl. No.: 15/987,765

(22) Filed: May 23, 2018

Related U.S. Application Data
(63) Continuation-in-part of application No. PCT/EP2016/077036, filed on Nov. 9, 2016.

(30) Foreign Application Priority Data
Nov. 24, 2015 (DE) 10 2015 120 307.3

(51) Int. Cl. G06T 11/20; F03D 17/00; G01W 1/10

(52) U.S. Cl. CPC G06T 11/206; G01W 1/10; F03D 17/00

(57) ABSTRACT

A method for graphically presenting sensor data from wind power installations is provided. A data interface of an apparatus receives sensor data from wind power installations and/or wind farms connected to the data interface. A memory stores the received sensor data. An input interface is used to select at least one current time or part time. Furthermore, a display interface is used to output signals for the purpose of presenting geographical maps and sensor values using a display. A plurality of sensor data or all sensor data for the selected time are retrieved from the memory, and the display interface outputs display signals to present the retrieved sensor signals with a map substantially at a position at which the wind power installation from which the respective sensor data were received is positioned. An apparatus for carrying out the method and a system having the apparatus are provided.

### BACKGROUND

### Technical Field

The invention relates to the presentation of sensor data which are acquired using sensors of wind power installations.

### Description of the Related Art

According to the prior art, any wind power installation has a plurality of different sensors in order to record operating parameters and/or environmental conditions on the basis of measured values. The values which are currently measured for this purpose and are in the form of sensor signals are used, for example, to control and/or regulate the wind power installation at the current time. Furthermore, however, sensor data are also provided, for example, for a maintenance service or the wind power installation operator in order to detect sensor values differing from standard values in the event of a fault and therefore be able to locate the fault location.

An operator also often has access to the past sensor values from one or more of his wind power installations in order to also be able to subsequently check, for example, electrical power generated in particular periods.

On account of favorable memory technology, extensive collections of sensor values are therefore stored in each wind power installation for a long period in the past and remain substantially unused.

In the priority application for the present application, the German Patent and Trademark Office researched the following prior art: EP 1 340 303 B1 and WO 2009/046 095 A1.

### BRIEF SUMMARY

The use of the sensor values which are stored in any case in wind power installations or control rooms of a control center for a plurality of wind power installations is improved.

In this case, preprocessing the sensor data in such a manner that they provide individual wind power installations with more than just knowledge of current or past operating states is provided.

An apparatus and a method for graphically presenting sensor data from a plurality of wind power installations are provided.

In this case, the method comprises the steps of using a data interface to receive sensor data containing sensor values, wherein a plurality of wind power installations and/or wind farms are connected to the data interface.

The method also comprises the step of using a memory to store the received sensor data from the wind power installations and/or wind farms. In addition, the method comprises using input devices, which are connected to an input interface and provide the input interface with input signals, to select at least one current time or one time in the past. In addition, the method comprises using a display interface to output display signals for the purpose of displaying geographical maps and sensor values using a display.

In addition, data processing devices are used to retrieve a plurality of sensor data or all sensor data for the selected time from the memory and the display interface is used to output them as display signals in order to use a display to present the retrieved sensor signals with a map in each case substantially at that position in the map which corresponds to the geographical position of the wind power installation from which the respective sensor data were received. The display signals are therefore output using the display interface and are generated beforehand by the data processing devices for this purpose.

The sensor data or sensor values from the wind power installations or wind farms, which are supplied via a data interface of an apparatus, are therefore stored in a memory of the apparatus. The input devices are then used, for example by a user, to select a time, and geographical maps and sensor values of the sensor signals are displayed, in particular in the form of symbols, on a display by means of display signals output via the display interface.

The display signals are therefore generated using the apparatus in order to use a display to present a plurality of sensor data or all sensor data for the time selected using the input devices. In this case, these sensor signals are presented with a map in each case at that position in the map which corresponds substantially to the geographical position, that is to say the real position, of the wind power installation from which the sensor data were received.

If a display is therefore connected to the display interface, a map is presented on the display and the sensor data, for example the sensor values included therein, of the selected time are respectively presented inside the map at that position at which the wind power installation is also actually positioned.

For example, a wind power installation is positioned at the northernmost point of a region, for example at the northernmost point of Germany, and transmits sensor values in the form of sensor signals to the apparatus. These sensor signals, which can also be called sensor data, are continuously stored in the apparatus, namely in a memory of the apparatus. These sensor data comprise, for example, values of the wind speed which are measured by an anemometer in the region of the wind power installation.

According to the example, the input devices are now used to select a time, for instance Dec. 1, 2014, 12:00,and the sensor data for the wind speed at this selected time are loaded from the memory and are presented on a map of Germany at the northernmost point of the region presented as the map in a display which is connected to the display interface.

If a multiplicity of wind power installations now provide sensor data, the sensor data for the selected time are presented at the different positions in the map of Germany which each correspond to the positions at which the wind power installations, from which the sensor data were respectively received, are positioned.

Different times and different sensor data can therefore be jointly presented on the overview, with the result that a quick overview wind speed distribution over a larger region, for example throughout Germany, can be presented in a very clear manner. It is particularly advantageous that these sensor data or sensor values can be presented at any desired time.

Qualitative statements relating to suitable locations or regions for wind power installations can therefore be verified, for example. In particular, local weather phenomena can also be detected by virtue of regions in which the sensor values differ greatly from values of other surrounding regions can be optically detected in a simple manner. A time at which a weather phenomenon arises can also be detected by selecting various times of interest.

According to one embodiment, the input devices are also used to select not only a time but also a period which therefore has a plurality of successive times. In this case, a period comprises a starting time and an end time, for example.

A time increment, for example 10 minutes, 1 hour, 24 hours, 1 week, 1 month or 1 year, is also selected. If a time increment is not predefined, the apparatus automatically predefines a standard time increment which, however, can be changed. Furthermore, the display interface is used to output a display signal which is used to gradually present the sensor data in succession for the selected period with the map using a display, wherein the duration between the steps corresponds to the selected time increment.

Therefore, the sensor data are thus gradually presented in the manner of a time lapse for the period by selecting the period and the time increment. An area of wind moving over an area or a region on a map can be tracked by means of this time-lapse presentation, for example. A storm front can therefore be pursued, for example after striking a region from any desired direction, and the distribution in the region can be observed.

Furthermore, shadowing effects for different wind directions or scenarios, which occur in other wind power installations, can be understood by individual wind power installations in a wind farm for different wind situations. This is used, for example, to reduce or prevent previously understood negative effects when planning or implementing further wind farms.

According to another embodiment, the input devices are used to select a repeat function, and the sensor data for the selected period are respectively gradually presented repeatedly, that is to say in a loop, with the selected time increment.

It is therefore simpler for a user to evaluate a multiplicity of items of sensor data with the display since the user can track the changes in the sensor data in the selected period again and again and can therefore optically evaluate different areas of the presented region or map in each pass without renewed interaction.

According to another embodiment, if the input devices are used to select the current time or no time at all as the end time of the period and gradual display of the sensor data is desired, the display interface is used to output the current sensor data at the presentation end of the selected period.

Therefore, the current sensor values are automatically presented after the last step of gradually presenting past sensor values, that is to say at the presentation end, with the result that a current overview of the current sensor data is immediately enabled again. In this case, current sensor data are, for example, the sensor data received last from a wind power installation at the current time.

According to one embodiment, the input devices are used to vary the section of the map to be presented. Therefore, an entire country, for example Germany, can be presented, for example, with the sensor data in a time-lapse presentation in a first overview, for example while said repeat function is being carried out, in which case areas of the map which are of particular interest can be magnified by inputting input signals via the input interface.

According to another embodiment, an interface is used to receive weather forecast data, for example the forecast wind direction and wind strength for different regions, from a weather forecast station or source of weather forecast data and the input devices are used to select future times or periods.

The data processing device of the apparatus is then used to forecast future sensor data for the selected time or period on the basis of the forecast and the previously stored sensor data, these future forecast sensor data for the selected time or period in the future then being presented on the map.

An overview utilization of different wind power installations and an associated utilization of the network can therefore be presented for times or periods in the future, for example.

The signals output using the display interface are also adapted by the data processing device in such a manner that a display connected to the display interface uses different colors in order to mark whether the presented sensor data are sensor data which are before a current time, are after a current time or are at a current time.

It is therefore possible to quickly optically perceive whether the presented sensor data are historical sensor data, forecast sensor data or currently acquired sensor data.

According to another embodiment, the data processing device is used to determine further values or information from the sensor data, in particular mean values of the power, wind speeds and/or the power distributed in the map section, for the time of the sensor values. The further values are therefore likewise assigned to a time. Furthermore, the further values are output to the display via the display interface in order to also display the further values of the selected time or period in addition to the sensor values using the display.

An apparatus for graphically presenting sensor data from a plurality of wind power installations and, in particular, for carrying out a method according to one of the embodiments of the method mentioned above is provided.

The apparatus comprises a data interface for connection to a plurality of wind power installations and/or wind farms by means of a data connection in order to receive sensor data from the connected wind power installations and/or wind farms. The apparatus also comprises a memory for storing the received sensor data from the wind power installations and/or wind farms and a display interface for outputting display signals for a display for displaying geographical maps and sensor values.

The apparatus also comprises an input interface for connecting input devices which are used to select at least one current time or one time in the past. Provision is also made of data processing devices which are set up to retrieve a plurality of sensor data or all sensor data for the selected time from the memory and to output display signals using the display interface in order to control a display in such a manner that a display can be used to present the retrieved sensor signals with a map in each case substantially at that position in the map at which the wind power installation, from which the respective sensor data were received, is positioned.

The apparatus therefore comprises the data interface, the memory, the display interface, the input interface and the data processing device. The input interface is used to connect an input device which may be arranged at a remote location. The connection between the input interface and the input device can be effected by means of an Internet connection, for example.

A display can also be arranged at a remote location and can be connected to the display interface via a data connection, with the result that a data connection can also be effected between the display interface and the display by means of a data connection, for example the Internet. However, it is also alternatively possible for the display and an input device to be arranged, together with the apparatus, at the same location, that is to say centrally.

It is therefore also possible to remotely access the apparatus via the Internet or another data network. The apparatus may be part of a control room or control center, for example, for this purpose.

According to one embodiment, the input interface, in particular with input device connected to the latter, can be used to select a period and/or a time increment in order to use the display interface to output control signals for controlling a display. According to this embodiment, the control signals are set up to use the display to gradually present the sensor data in succession for the selected period with the map, wherein the duration between two presentation steps corresponds to the selected time increment.

A time-lapse representation of the change in the sensor data is therefore possible for a selected period. According to another embodiment, the time increment is set to a predefined value which, however, can be changed using the input interface, in particular using an input device.

According to another embodiment, the input interface, in particular using the input device, can be used to select a repeat function in order to repeatedly present the sensor data for the selected period in a loop. The presentation in a loop simplifies the optical evaluability by a user.

According to another embodiment, if the input interface, in particular using the input device, is used to select the current time or no time as the end time of the period, the current sensor data are automatically presented in the map at the end of the output of display signals for presenting the period.

According to another embodiment, the input interface is set up, in particular using the input device, to vary a section of the map which can be presented using the display, that is to say to magnify or reduce said section or to change to the region or area.

According to another embodiment, the apparatus comprises an interface for connection to a source of weather forecast data, in particular the wind direction and wind strength, and for receiving the weather forecast data, wherein the input interface, in particular using an input device, can also be used to select future times or periods, and the data processing device is set up to forecast future sensor data on the basis of the weather forecast data and stored values of the sensor data and to output display signals using the display interface in order to present the forecast sensor data with the map on a display.

According to another embodiment, the data processing device is set up to use the display to optically mark, for example by means of different colors, whether the presented sensor data are sensor data which are before a current time, are after a current time or are at a current time.

According to another embodiment of the data processing device, the latter is set up to determine further values, in particular mean values of the power, wind speed and/or the power distributed in the map section, from a plurality of sensor values of the selected time in order to use the display interface to output display signals for the purpose of controlling a display in order to output the further values, together with the sensor data for the same time, using the display.

Provided is a system having a plurality of wind power installations and/or wind farms and an apparatus according to one of the embodiments mentioned above, in particular for carrying out one of the embodiments of the method mentioned above.

### BRIEF DESCRIPTION OF THE SEVERAL VIEWS OF THE DRAWINGS

Further embodiments emerge on the basis of the exemplary embodiments explained in more detail in the drawings, in which:

FIG. 1 shows a wind power installation,

FIG. 2 shows a wind farm,

FIG. 3 shows an apparatus according to the invention, and

FIG. 4 shows a map containing sensor data.

### DETAILED DESCRIPTION

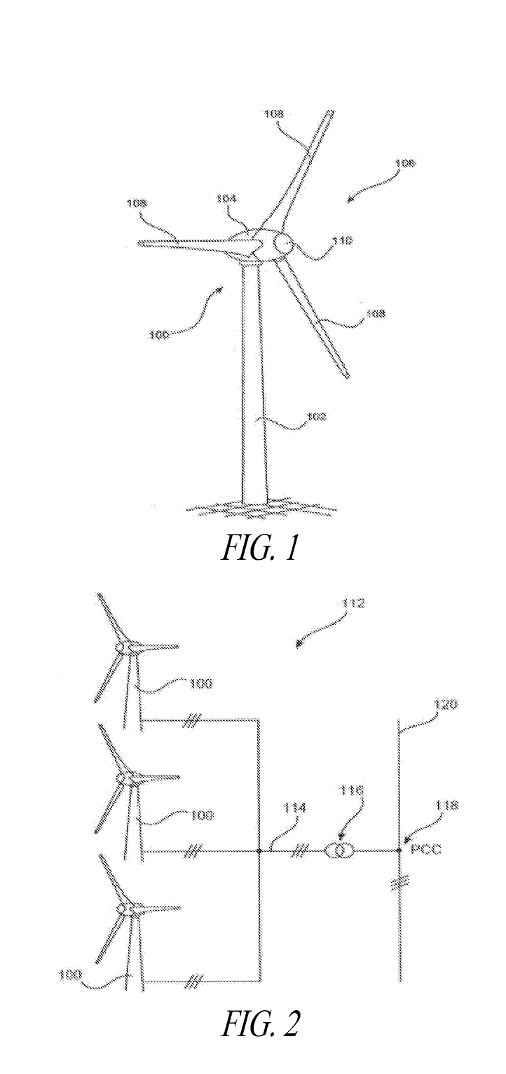

FIG. 1 shows a schematic illustration of a wind power installation. The wind power installation 100 has a tower 102 and a nacelle 104 on the tower 102. An aerodynamic rotor 106 having three rotor blades 108 and a spinner 110 is provided on the nacelle 104.

The aerodynamic rotor 106 is caused to carry out a rotational movement by the wind during operation of the wind power installation and therefore also rotates a rotor of a generator which is directly or indirectly coupled to the aerodynamic rotor 106. The electrical generator is arranged in the nacelle 104 and generates electrical energy. The pitch angles of the rotor blades 108 can be changed by means of pitch motors on the rotor blade roots 108b of the respective rotor blades 108.

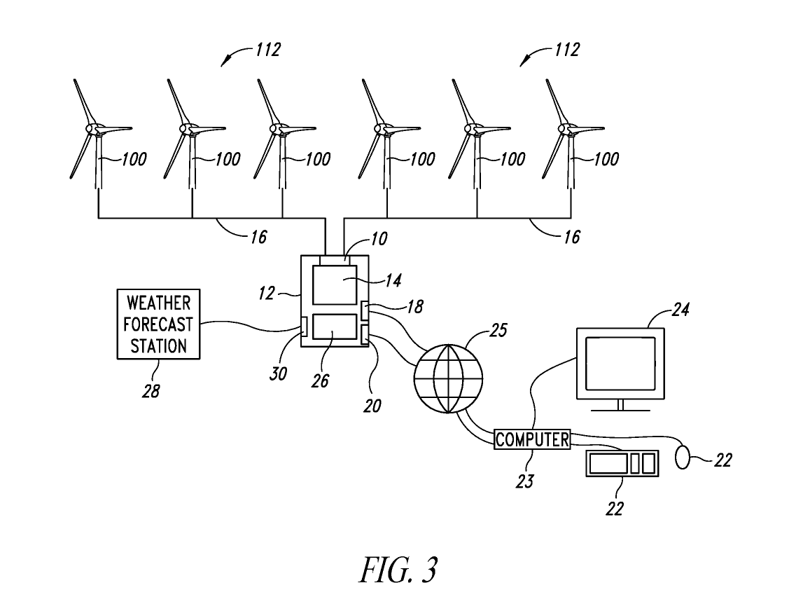

FIG. 2 shows a wind farm 112 having, by way of example, three wind power installations 100 which may be identical or different. The three wind power installations 100 are therefore representative of fundamentally any desired number of wind power installations in a wind farm 112.

The wind power installations 100 provide their power, namely the current generated, in particular, via an electrical farm network 114. In this case, the currents or powers respectively generated by the individual wind power installations 100 are added, and a transformer 116 is usually provided, which transformer steps up the voltage in the farm in order to then feed it into the supply network 120 at the feed-in point 118 which is also generally referred to as the PCC.

FIG. 2 is only a simplified illustration of a wind farm 112 which does not show any controller, for example, even though a controller is naturally present. The farm network 114 may also be different, for example, by virtue of a transformer, for example, also being present at the output of each wind power installation 100, to name just one other exemplary embodiment.

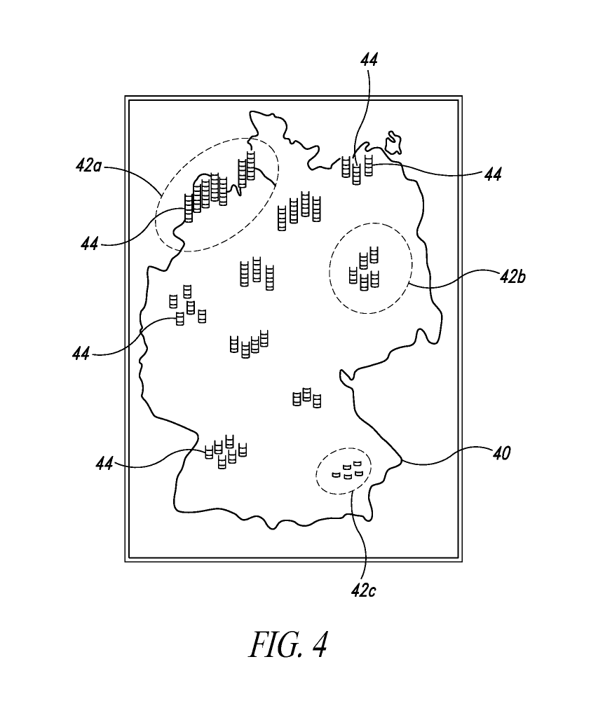

FIG. 3 shows two wind farms 112 representative of a multiplicity of wind farms 112 which are connected to an apparatus 12 via a data interface 10. The apparatus 12 has a memory 14 for storing sensor data 16 which are received via the data interface 10. The apparatus also comprises a display interface 18 and an input interface 20. The input interface 20 is used to directly or indirectly connect input devices 22. An interface, such as the input interface 20, may be any type of wired or wireless communication device, e.g. a device configured to communicate with another device. In one embodiment, the input interface may be a communication port or modem, among others. The input interface may be a USB port, PCI slot, among many others. The input devices 22 correspond here to a computer mouse and a keyboard. In the present case, the input devices 22 are indirectly connected to the input interface 20 via a computer 23.

A display 24 which is directly or indirectly connected to the display interface 18 is also illustrated. In the present case, the display 24 is also indirectly connected to the display interface 18 via the computer 23. The connections between the display 24 and the display interface 18 and between the input device 22 and the input interface 20 using the computer 23 can be effected, for example, via an Internet connection 25, with the result that it is possible to remotely query the apparatus 12 with a display 24 positioned at a remote location and input devices 22.

The input device 22 can be used to select times and periods for which the sensor data 16, that is to say their sensor values or values in particular, are presented together with a map on the display 24. For this purpose, the apparatus has data processing device 26 which load stored sensor data 16 from the memory 14, according to the input using the input device 22, and output said data together with the map, in the form of display signals, via the display interface 18.

The data processing device 26 may be any type of device equipped with computing functionality and configured to perform computational operations. For example, the data processing device 26 may be a processor, microprocessor, controller or microcontroller, among others. The data processing device 26 may be a central processing unit (CPU) or a graphics processing unit (GPU), among others. The data processing device 26 may have an arithmetic logic unit (ALU), floating-point unit (FPU), or any other type of combinational or non-combination logic circuitry.

The data processing device 26 receives the sensor data and weather forecast data. The data processing device 26 processes the sensor data and weather forecast data and generates other data based on the sensor data or the weather forecast data.

The display signals are generated by the data processing device 26 in such a manner that the display 24 is controlled such that the sensor data of the selected times or periods are presented in the map on the display 24.

The apparatus 12 is also connected to a weather forecast station 28 via an interface 30 of the apparatus 12. The weather forecast station 28 provides forecast weather data via the interface, with the result that sensor data forecast on the basis of the sensor data 16 and the weather data received from the weather forecast station 28 can be forecast by the data processing device 26 for future times or periods and can be presented together on a map using the display 24.

FIG. 4 shows a section of a map 40 presented using the display 24 according to one exemplary embodiment. The map 40 is here a map of Germany, in which case sensor data from wind power installations 100 are presented in different areas or regions 42a, 42b, 42c.

The map is presented here for a time input using the input device 20. The individual columns or symbols 44 presented in the areas 42a to 42c symbolize the wind speed measured values of the sensor data 16 presented at the selected time. The higher the column 44, the higher the wind speed at this location at the selected time presented here.

For example, the columns in the area 42a, which are in the area of the North Sea coast region, are higher than the columns 42c, which are positioned in the south-eastern Alps area. Other columns 44 have other values.

Each column represents one or more wind power installations which is/are actually arranged substantially at the position presented in the map 40 on the display 24.

In the present exemplary embodiment, only a few of the wind power installations 100 which are actually present and are connected to the apparatus 12 are presented in the display 24 by means of selection using the input device 20. In this case, only wind power installations or their sensor data representative of particular regions are selected, for example, in order to show the change in the measured wind speed in a time-lapse function, namely in a gradual presentation of a past period.

Thanks to the presentation of the map 40 with the sensor data in the form of columns 44 or in the form of other symbols, a user can obtain a quick optical overview of the progression of a wind front, for example, which strikes a country or a region on one side and is then distributed in the interior of the country. The user can draw further conclusions herefrom, for example for the effects of future weather phenomena.

1. A method for graphically presenting sensor data from a plurality of wind power installations or wind farms, comprising:
receiving, by a data interface of an apparatus, sensor data from the plurality of wind power installations or wind farms connected to the data interface,
storing, by a memory, the received sensor data,
receiving, from an input device, a selection of a time that is at least one of a current time or a past time,
retrieving a plurality of sensor data for the selected time from the memory, and
outputting, over a display interface, display signals representative of a geographical map and the plurality of sensor data, each sensor data of the plurality of sensor data being at a position in the geographical map which corresponds substantially to a geographical position of a wind power installation or wind farm of the plurality of wind power installations or wind farms which captured the respective sensor data.

2. The method as claimed in claim 1, comprising:
receiving, from the input device, a selection of a period and a time increment, and wherein:
outputting the display signals includes outputting the display signals indicating gradual display of the plurality of sensor data in succession for the selected period in the geographical map, wherein the selected time increment is a duration between two successive presentations.

3. The method as claimed in claim 2, comprising:
receiving, from the input device, a selection of a repeat function, and wherein:
outputting the display signals includes outputting the display signals indicating repeated gradual display of the plurality of sensor data over the selected period.

4. The method as claimed in claim 2, comprising:
receiving, from the input device, a selection of a current time or no time as an end time of the period,
outputting, over the display interface, display signals representative of the plurality of sensor data includes automatically outputting the display signals representative of current sensor data for if an end of the selected period has been reached.

5. The method as claimed in claim 1, comprising:
receiving, from the input device, an input indicating a variation of a section of the geographical a map to be displayed on the display.

6. The method as claimed in claim 1, comprising:
receiving, over a weather interface communicatively coupled to a source of weather forecast data, weather forecast data,
receiving, from the input device, a selection of a future time or period,
forecasting future sensor data for the selected future time or period based on the weather forecast data and the stored sensor data, and wherein outputting the display signals includes outputting the weather forecast data.

7. The method as claimed in claim 1, wherein outputting the display signals includes: assigning different colors to sensor data that are before a current time, after a current time or at a current time during display of the plurality of sensor data on the display.

8. The method as claimed in claim 1, comprising:
determining, by a processor, further values based on the plurality of sensor data of the selected time, and wherein outputting the display signals includes outputting the display signals are representative of the further values and the sensor values of the same time for display together with the plurality of sensor data on the display.

9. An apparatus for graphically displaying sensor data from a plurality of wind power installations, comprising:
a data interface operable to be connected to a plurality of wind power installations or wind farms using a data connection and configured to receive a plurality of sensor data from the plurality of wind power installations or wind farms,
a memory configured to store the received sensor data from the plurality of wind power installations or wind farms,
a display interface configured to output display signals for displaying geographical maps and sensor values by a display,
an input interface configured to receive input signals from an input device for selecting a time that is at least a current time or a past time, and
a processor configured to:
retrieve the plurality of sensor data for the selected time from the memory,
output the display signals using the display interface to display the plurality of sensor data with the geographical map, wherein each sensor data is displayed at a position in the geographical map which substantially corresponds to a geographical position of a wind power installation or wind farm of the plurality of wind power installations or wind farms from which the respective sensor data was received.

10. The apparatus as claimed in claim 9, wherein the input interface is configured to receive a selection of a time period or time increment, and the display interface is configured to output the display signals to cause the display to gradually present the plurality of sensor data in succession for the selected time period together with the geographical map, wherein a duration between two presentation steps corresponds to the selected time increment.

11. The apparatus as claimed in claim 10, wherein the input interface is configured to receive a selection of a repeat function for repeatedly presenting the plurality of sensor data for the selected period, and receive an input for varying a section of the displayed geographical map to be presented using the display under the control of the display signals from the display interface.

12. The apparatus as claimed in claim 9, comprising:
a weather forecast interface operable to be connected to a source of weather forecast data and configured to receive the weather forecast data, and wherein the input interface is configured to receive a selection of a future time or period, and the processor is configured to forecast future sensor data for the selected time or period based on the weather forecast data and the plurality of sensor data and to output display signals, via the display interface, indicative of the plurality of sensor data and the geographical map.

13. The apparatus as claimed in claim 9, wherein the processor is configured to output, over the display interface, the display signals to control the display in such a manner that different colors are used on the display to mark whether displayed sensor data are sensor data which are before a current time, after a current time or at a current time.

14. The apparatus as claimed in claim 9, wherein the processor is configured to determine further values from a plurality of sensor values of the selected time and to use the display interface to output the further values, together with the signals for the sensor data of the selected time or period, for presentation on the display.

15. A system, comprising:
the plurality of wind power installations or wind farms,
the apparatus as claimed in claim 9, wherein the apparatus is connected, over data interface, to the plurality of wind power installations or wind farms via a data connection.

16. The method as claimed in claim 6, wherein the weather forecast data includes a wind direction or wind strength.

17. The method as claimed in claim 8, wherein the further values includes a mean of a power, wind speed or power distribution in a section of the map.

18. The apparatus as claimed in claim 12, wherein the weather forecast data includes a wind direction or wind strength.

19. The apparatus as claimed in claim 14, wherein the further values includes a mean of a power, wind speed or power distribution in a section of the geographical map.
